(19) United States
(12) Patent Application Publication
(10) Pub. No.: US 2026/0252266 A1
(43) Pub. Date: Aug. 27, 2026

(54) STATUS AGGREGATION

(71) Applicant: Arm Limited, Cambridge (GB)

(72) Inventors: Ho-Seop Kim, Austin, TX (US); Koustav Bhattacharya, Austin, TX (US); Klas Magnus Bruce, Leander, TX (US); Dimitrios Kaseridis, Austin, TX (US); Kevin Neal Magill, Durham, NC (US)

(73) Assignee: Arm Limited, Cambridge (GB)

(21) Appl. No.: 19/170,802

(22) Filed: Apr. 4, 2025

(30) Foreign Application Priority Data
Feb. 26, 2025 (EP) 25300009.5

(51) Int. Cl. G06F 3/06

(52) U.S. Cl. CPC G06F 3/0658; G06F 3/0613; G06F 3/0688

(57) ABSTRACT

An apparatus comprises requester interface circuitry which receives response flits from a memory system interconnect. A given response flit specifies a status indication indicative of a status of a memory system node associated with the given response flit, and is associated with at least one further response flit property other than the status indication. Status aggregation circuitry combines respective status indications from received response flits to generate an aggregate status indication. Control circuitry controls, based on the aggregate status indication generated by the status aggregation circuitry, a rate of memory system transactions initiated to the memory system interconnect by the requester interface circuitry. The status aggregation circuitry selects, depending on said at least one further response flit property of the given response flit, a weighting with which the status indication of the given response flit influences the aggregate status indication.

### BACKGROUND

### Technical Field

The present technique relates to the field of data processing systems.

### Technical Background

A requester capable of initiating memory system transactions to a memory system interconnect may receive, in a response flit received from the memory system interconnect, a status indication providing information on current status of a memory system component associated with the response flit. The status indication can be used to control issuing of memory access transactions to the memory system interconnect.

### SUMMARY

At least some examples of the present technique provide an apparatus comprising: requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication; status aggregation circuitry configured to combine respective status indications from a plurality of response flits received by the requester interface circuitry to generate an aggregate status indication; and control circuitry configured to control, based on the aggregate status indication generated by the status aggregation circuitry, a rate of memory system transactions initiated to the memory system interconnect by the requester interface circuitry; in which: the status aggregation circuitry is configured to select, depending on said at least one further response flit property of the given response flit received by the interface circuitry, a weighting with which the status indication of the given response flit influences the aggregate status indication.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus comprising: requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication; status aggregation circuitry configured to combine respective status indications from a plurality of response flits received by the requester interface circuitry to generate an aggregate status indication; and control circuitry configured to control, based on the aggregate status indication generated by the status aggregation circuitry, a rate of memory system transactions initiated to the memory system interconnect by the requester interface circuitry; in which: the status aggregation circuitry is configured to select, depending on said at least one further response flit property of the given response flit received by the interface circuitry, a weighting with which the status indication of the given response flit influences the aggregate status indication.

At least some examples of the present technique provide a method comprising: receiving a plurality of response flits at requester interface circuitry in response to memory system transactions initiated to a memory system interconnect by the requester interface circuitry, a given response flit specifying a status indication indicative of a status of a memory system node associated with the given response flit, where the given response flit is associated with at least one further response flit property other than the status indication; combining respective status indications from the plurality of response flits received by the requester interface circuitry to generate an aggregate status indication, wherein a weighting with which the status indication of the given response flit influences the aggregate status indication is selected depending on said at least one further response flit property of the given response flit; and controlling, based on the aggregate status indication, a rate of memory system transactions initiated to the memory system interconnect by the requester interface circuitry.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising requester interface circuitry, status aggregation circuitry, and control circuitry;

FIG. 2 illustrates an example of a data processing apparatus comprising the apparatus of FIG. 1;

FIG. 3 illustrates an example of communication channels between the requester interface circuitry and a memory system interconnect;

FIG. 4 illustrates an example of the status aggregation circuitry;

FIG. 5 illustrates steps for controlling rate of memory system transactions based on status indications from response flits;

FIG. 6 illustrates a more specific example of steps for controlling memory access request control operating mode based on status indications from response flits detected in a sampling period;

FIGS. 7 to 12 illustrate various examples of selecting, based on at least one further response flit property, a weighting for aggregating the status indication from a given response flit into an aggregation status indication; and

FIG. 13 illustrates a system and a chip-containing product.

### DESCRIPTION OF EXAMPLES

An apparatus has requester interface circuitry configured to initiate memory system transactions to a memory system interconnect and to receive, in response to the memory system transactions, response flits from the memory system interconnect. A given response flit specifies a status indication indicative of a status of a memory system node associated with the given response flit. As well as specifying the status indication, the given response flit is also associated with at least one further response flit property other than the status indication. The apparatus also has status aggregation circuitry configured to combine respective status indications from a plurality of response flits received by the requester interface circuitry to generate an aggregate status indication; and control circuitry configured to control, based on the aggregate status indication generated by the status aggregation circuitry, a rate of memory system transactions initiated to the memory system interconnect by the requester interface circuitry.

Hence, by providing a feedback mechanism by which memory system nodes can communicate their status to a requester interface capable of initiating memory system transactions to the memory system interconnect, aggregating the status information from multiple response flit into an aggregate measure of system status, and using that aggregate measure to regulate rate of memory system transactions initiated to the memory system interconnect by the requester interface circuitry, this can help to improve processing performance in a data processing system. For example, the control circuitry could use knowledge of high aggregate memory system load to decide to reduce the rate at which memory system transactions are initiated, to reduce risk that performance-critical transactions are delayed due to being blocked from progressing because they cannot obtain use of sufficient memory system resource. By aggregating status indications from multiple response flits to produce an aggregate measure used to control rate of memory system transactions, this can be helpful to reduce inefficiencies that could arise if each status indication was responded to individually, which might cause repeated cycles of increasing and decreasing aggressiveness of issuing memory system transactions.

However, in typical status aggregation schemes, each item of status information from a given response flit is given equal weight in the aggregation mechanism, so that each item of status information contributes equally to the overall aggregate measure of system status provided by the aggregate status indication. The inventors recognized that such an approach may lead to performance inefficiencies because it may cause the control circuitry to over-react to status indications provided in response flits of a class that are relatively unlikely to have much bearing on overall memory system performance. For example, treating all items of status indication as having equal weight in the status aggregation function could lead to over-throttling of memory system transactions due to a status update from a memory system component that actually has relatively little influence on the overall levels of system performance seen by the system as a whole.

Hence, in the examples discussed below, the status aggregation circuitry is configured to select, depending on at least one further response flit property of the given response flit received by the interface circuitry, a weighting with which the status indication of the given response flit influences the aggregate status indication. With this approach, status updates are not all treated equally from the point of view of updating the aggregate status indication, and some response flits may have a greater influence on the aggregate status indication than others even if they specify the same value for the status indication. The status aggregation circuitry can reduce the weight given to status updates made in response to a class of response flits for which the at least one further response flit property indicates that the status information is relatively unlikely to reflect a status that will have a significant effect on overall system performance, while giving more weight to other status updates made in response to classes of response flits for which the at least one further response flit property indicates that the status information is more likely to reflect a status that will have a more significant effect on overall system performance. Analysis of simulation results has shown that such a weighted status aggregation scheme can benefit overall processing performance for workloads simulated as being processed on a processing system. Hence, by selecting a variable weighting for a given response flit, which adjusts the influence the status indication of that given response flit has on the aggregate status indication, this can provide an aggregate status indication which is more representative of factors that actually influence overall system performance, so that a more performance-efficient memory access control scheme can be implemented by the control circuitry.

The status indication can be any information indicating status of an associated memory system node associated with the given response flit. The memory system node associated with the given response flit could be a node from which the given response flit is received or a node which is responsible for generation of contents of the response flit, or in some cases an intermediate memory system node via which the response flit is routed when transferred from a source memory system node to the requester interface circuitry. In some examples, the status indication could be information that expresses status other than a level of busyness for the associated memory system node (e.g. information indicating a current operating mode of the associated memory system node, or information indicating whether an error condition has arisen that might affect the memory system node’s ability to service memory system transactions, etc.).

However, the techniques discussed in this application can be particularly useful where the status indication comprises a busyness indication indicative of a level of busyness for the memory system node associated with the given response flit. Here, the term “busyness” is intended to refer to a measure of how busy the associated memory system node is, and is distinct from the term “business” referring to commercial or economic activity. One of the main causes of loss of processing performance in a data processing system is delays in accessing memory due to insufficient capacity for a given memory system component to handle additional requests (e.g. a memory system component may have limited bus bandwidth or buffer capacity available for requesting new requests, so once that is used up or close to being used up, this may cause delays in servicing other requests). This may be particularly problematic if some performance-critical memory accesses are delayed due to the memory system resource already being busy for handling other memory access requests which might be less performance-critical. By providing information about a level of busyness to requester interface circuitry responsible for initiating memory system transactions to the memory system interconnect, that requester can use its control circuitry to regulate the flow of memory system transactions, e.g. by reducing the rate of less performance-critical accesses (e.g. speculative accesses such as prefetch requests) so that the system has more resource available for handling other accesses.

The particular response flit property (or set of two or more response flit properties) used by the status aggregation circuitry to select the weighting can vary from one implementation to another. A variety of properties of response flits could be used for selecting the weighting. The at least one response flit property can be any information that can be determined for a given response flit that distinguishes a feature of that response flit from another response flit not having that feature. The at least one further response flit property could be explicitly specified by the encoding of the response flit, or could be implicitly associated with the response flit, e.g. by being implicit from a physical channel on which the response flit is received.

For example, for some implementations, the at least one further property used by the status aggregation circuitry to select the weighting comprises a source-indicating property indicative of a source memory system node for the given response flit. The source-indicating property could be explicitly identified by source node identifying information encoded in the given response flit, or could be implicitly identified (e.g. if there are dedicated wired channels associated with receiving response flits from different source memory system nodes, the source-indicating property could be implicit from which particular wired channel the given response flit was received on). Considering information indicative of the source memory system node associated with a given response flit when determining the weight with which that response flit’s status update should be applied to the aggregate status indication can be helpful, because different source memory system nodes may have different effects on overall memory system performance.

There could be different ways of defining what memory system node is considered the source memory system node for a given response flit. In some examples, the source memory system node can be a node from which the given response flit is received (either directly or indirectly via other intermediate nodes). In some cases, the source memory system node could be the ultimate source of the read data or other contents of the response flit (e.g. the node responsible for first generating a packet containing that data). In other cases, the source memory system node could be an intermediate source via which the response flit was routed from the ultimate source node to the requester interface circuitry (e.g. the intermediate source could be a chip-to-chip link providing communication between respective chips of a multi-chip system). In some cases, the source memory system node indicated by the source-indicating property could be the same component whose status is indicated by the status indication. In other cases, the source memory system node identified by the source-indicating property could be a different memory system node to the memory system node whose status is indicated by the status indication, or could be different (e.g. the source memory system node might be considered to be the ultimate data source of the data represented by the response flit, but while the response flit is on route to the requester interface circuitry, an intervening component may have replaced the status indicated by the ultimate data source with status information indicating status of an intervening component such as a chip-to-chip communication link). Hence, it will be appreciated that there is a wide variety of design scope for a system designer to set how the source-indicating property and the status information are set for a given response flit routed from a given memory system component to the requester interface circuitry. Regardless of the exact manner in which the source-indicating property and the status information are generated, it can be helpful to be able to determine, in a source-specific manner dependent on the source-indicating property, a variable weighting based on which source memory system node is responsible for a response flit associated with status information, to allow status updates from different source nodes to be treated as having different levels of influence on the aggregate measure being maintained at the requester side for the purpose of regulating flow of memory system transactions initiated by that requester.

In some examples, at least when the given response flit is a response flit of at least one predetermined response flit type, the status aggregation circuitry may select a higher weighting for the status indication of the given response flit when the source-indicating property indicates a slower source memory system node expected to provide slower access latency for servicing memory system transactions initiated by the requester interface circuitry than when the source-indicating property indicates a faster source memory system node expected to provide faster access latency for servicing memory system transactions initiated by the requester interface circuitry. Resource constraints arising at slower memory system nodes tend to have a greater impact on overall system performance than resource constraints arising at faster memory system nodes, because the impact of any delays caused by insufficient bandwidth to handle more requests is greater for components where the access latency per transaction is expected to be slower. Hence, it can be preferable to give higher weighting to status updates from slower source memory system nodes than status updates from faster source memory system nodes, so that the updates from the slower components have more influence over the aggregate status indication and so the rate control applied by the control circuitry is more likely to prioritise alleviating any resource constraints associated with the slower source memory system nodes. This can give improved system performance overall.

Note that the definition of source memory system nodes as “faster” and “slower” is a relative one, from the perspective of a particular requester interface. Although in some cases the faster memory system node might be inherently faster in an absolute sense (e.g. having circuitry implemented with a faster form of memory storage technology, say), in other cases it may be that the slower memory system node is not necessarily inherently slower than the faster memory system node (e.g. in some cases the slower and faster memory system nodes might be functionally identical – e.g. implemented using identical forms of memory storage technology). For example, a difference in access latency experienced by a particular requester interface might simply be due to the physical distance between the requester interface circuitry and the memory system nodes, with the faster memory system node being closer to the requester interface circuitry than the slower memory system node, so subject to lower signal propagation latencies. Hence, it will be appreciated that the terms “faster” and “slower” are intended to be relative terms defined from the point of view of a particular instance of the requester interface circuitry, and which of a pair of memory system nodes is regarded as faster or slower may vary from one instance of the requester interface circuitry to another instance of the requester interface circuitry.

There could be a number of reasons why one memory system node may be considered faster than another, including factors relating to the physical placement in the system, the level of a memory system hierarchy at which the memory system nodes are located (e.g. which level of cache in a cache hierarchy is accessed), whether or not the memory system node is on a same chip or remote chip as the requester interface circuitry, and/or the particular type of memory storage technology used to implement storage associated with the memory system node. Hence, any one or more of these factors could be considered in determining whether one memory system node is likely to give faster or slower access latency than another, and hence use that knowledge to assign a higher weighting to a component likely to be slower to access than to a component likely to be faster to access.

For example, in some examples, at least when the given response flit is a response flit of at least one predetermined response flit type, the status aggregation circuitry may select a higher weighting for the status indication of the given response flit when the source-indicating property indicates that the source memory system node is a memory controller configured to control access to an associated array of random access memory (RAM) cells, than when the source-indicating property indicates that the source memory system node is home node circuitry configured to manage coherency of data held by a plurality of caches associated with a plurality of requesters or a system cache shared between the plurality of requesters. The memory controller responsible for controlling access to an associated array of RAM cells is likely to be slower to access than storage associated with home node circuitry or a system cache, so resource constraints at the memory controller may have a greater impact on overall system performance as any delay amplifies the slow response taken by the memory controller. Hence, it can be useful to assign a higher weighting to status updates from a memory controller than for updates from the home node circuitry or system cache.

In some examples, at least when the given response flit is a response flit of at least one predetermined response flit type, the status aggregation circuitry may select a higher weighting for the status indication of the given response flit when the source-indicating property indicates that the source memory system node is a remote memory system node on a different chip to the requester interface circuitry, than when the source-indicating property indicates that the source memory system node is a local memory system node on a same chip as the requester interface circuitry. As communication delays across a chip boundary are often significantly slower than communication delays within a chip, it can be useful to assign higher weighting to status updates from source components on a remote chip, so that the aggregate status indication is more dependent on current status of components at the remote chip. This reduces the likelihood of performance unnecessarily being sacrificed by over-throttling memory system transactions in cases where the components reporting high busyness are the local components on a same chip which are less likely to have much influence on overall system performance for the transactions issued by the requester interface circuitry. The control circuitry can then focus on regulating memory system transactions to try to prioritise throughput for the slow transactions targeting a remote chip, based on the level of busyness or other status at a component of the remote chip.

In some examples, at least when the given response flit is a response flit of at least one predetermined response flit type, the status aggregation circuitry is configured to select a higher weighting for the status indication of the given response flit when the source-indicating property indicates that the source memory system node is a memory controller associated with a memory storage array implemented according to a first memory storage technology than when the source-indicating property indicates that the source memory system node is a memory controller associated with a memory storage array implemented according to a second memory storage technology. For example, the first memory system storage technology may be a technology which provides slower access latency than the second memory system storage technology. Examples of different memory storage technologies include, for sake of example, dynamic random access memory (DRAM), disaggregated memory (e.g. memory accessed via I/O mechanisms such as over a CXL or PCIe communications interface) and high bandwidth memory (HBM). It will be appreciated that these examples are non-exhaustive and for any given pair of memory storage technologies, an evaluation may be made of which storage technology is likely to give faster access latency and/or able to tolerate higher rates of memory system transactions such as prefetch transactions. For example, HBM may be able to tolerate higher rates of transactions than DRAM and so status updates indicating overloading of components associated with accessing DRAM may be given higher weighting than status updates indicating overloading of HBM. Hence, with this example, the first memory system storage technology may be DRAM and the second memory system storage technology may be HBM. For disaggregated memory, the latency and bandwidth that can be supported may depend on the width of the I/O channel (e.g. CXL or PCIe link) that is provided, so the disaggregated memory could be either faster or slower than DRAM depending on the interface implementation. Regardless of the particular form of memory storage technologies used, by giving higher weight to status updates from memory storage components implemented with a slower memory storage technology than status updates from memory storage components implemented with a faster memory storage technology, the aggregate status indication can better track the expected pinch points in memory system performance to give better information for regulating rate of memory system transactions.

In the examples discussed above, the source-indicating property is used to adjust the weight given to a particular status update for a given response flit. It is not essential to consider the source-indicating property for all response flits. In some examples, the source-indicating property might be considered only for one or more particular types of response flits and other types of response flits may have the weighting selected independent of any source-indicating property.

For example, in some examples, the at least one predetermined response flit type (for which the source-indicating property is considered when determining the weighting to use for the status information update) comprises a data-providing read response flit which provides read data returned in response to a read memory system transaction initiated by the requester interface circuitry. For response flits which provides read data, it can be particularly useful to identify the source of that read data as this may affect the likely latency that would arise if the source component is prevented, due to insufficient resource, from handling additional requests targeting that source component, so the source-indicating property may be particularly useful information for selecting the weighting when a read response flit is being processed. For other types of response flits the overall system performance may be less sensitive to the particular source component from which the response flit is received, so for those other response flits, the source-indicating property might not be considered by the status aggregation circuitry when determining the weighting.

Another example of a flit property (that can be used to adjust the weighting for the status update performed in response to a given response flit) can be a response flit type associated with the given response flit. For example, the response flit type could be determined from an opcode encoded in the response flit, which identifies the type of response flit, and/or could be at least partially implicit from which physical channel is used to receive the given response flit (in some examples, the response flit type may be determined as a combination of the physical channel and an opcode). The inventors recognised that some response flit types may provide status information, but updating the aggregate status measure in response to that status information may not as beneficial as similar updates to the aggregate status measure made in response to other response flit types. For example, it might be that some memory system transaction flows involve receipt of multiple response flit types when dealing with the same initial memory system transaction, so that treating each of the response flit types equally might risk that memory system transaction being given disproportionate weight in influencing the aggregate measure of status than another transaction type which causes fewer response flits to be received. Therefore, it can be helpful to determine a weighting which is variable based on information identifying the response flit type of the response flit that provides the status information.

For example, the status aggregation circuitry may select a lower weighting for the status indication of the given response flit when the given response flit is a non-data-providing read response flit than when the given response flit is at least one other type of response flit. The non-data-providing read response flit is a response flit which is returned in response to a read memory system transaction initiated by the requester interface circuitry and is separate from a data-providing read response flit providing read data returned in response to the read memory system transaction. For example, the non-data-providing read response flit could be a read response returned on a response channel of the requester interface circuitry (as opposed to a read data response returned on a data channel of the requester interface circuitry). Some memory system interconnect protocols may support the ability to return an initial read response flit for a given memory system transaction separately from the read data returned in response to that same memory system transaction. The inventors recognised that it tends to be the status information in the data-providing read response flit that actually returns the read data which is more influential in representing bottlenecks of system performance that may be desirable to address by regulating flow of memory system transactions based on the aggregate status indication. The initial non-data-providing read response flit is less influential, because it may be returned from a home node or other system component that tends to have faster access latency in comparison to the component returning the read data itself, so it can be useful to give lower weight to the non-data-providing read response flit than the data-providing read response flit. Another reason why reducing the weighting for the non-data-providing read response flit can be useful is that there may be some time that passes between receiving the non-data-providing read response flit and receiving the data-providing read response flit, so the status information returned in the non-data-providing read response flit may no longer be accurate at the time when the read data is actually received, and the status information from the data-providing read response flit better reflects underlying system conditions at the time when the memory access is completed. Hence, by filtering out, or reducing the impact of, updates to the aggregate status indication made in response to a non-data-providing read response flit, the aggregate status indication better tracks prevailing system conditions which are likely to impact on system performance.

It will be appreciated that, in some examples, the response flit type may be regarded as implicitly providing information about the source memory system node associated with the response flit type. For example, one type of response flit may inherently be assumed to be generated by a particular source memory system node. For example, the non-data-providing read response flit described above may be considered to be generated by a home node or system cache, while the data-providing read response flit might be generated by a component associated with a data storage array such as a DRAM or flash memory storage unit. Hence, the source-indicating property mentioned earlier could in some examples include the response flit type and may not always need to include an explicit identifier of a particular source node, as the source-indicating property could be implicit from response flit type.

In some examples, the at least one further response flit property used by the status aggregation circuitry to select said weighting may comprise a data size indication indicative of a number of bytes of read data represented by the given response flit as being returned in response to a corresponding read memory system transaction. Some memory system interconnect protocols may support the ability for a given response flit to represent read data of varying data size, e.g. by supporting compression to compress a block of data into smaller size by exploiting data elision techniques such as run length encoding (encoding a number of consecutive repetitions of a given set of bits using a single instance of the repeated bit pattern and an indication of the number of repetitions) and/or codebook encoding (encoding a commonly occurring bit pattern (e.g. all zeroes) using a symbol with fewer bits). For a memory system component able to compress the data awaiting transmission into fewer response flits and a memory system component which requires more response flits to transmit an equivalent amount of data, resource constraints at these components may have differing effects on overall system performance, so that it can be useful to take into account the data size indication of a given response flit when determining the weighting with which to apply the corresponding update to the aggregate status indication based on the status indication of the given response flit.

Different examples could have differing approaches to adjusting the weighting depending on the data size indication. In some examples, the status aggregation circuitry may select a higher weighting for the status indication of the given response flit when the data size indication is indicative of a greater number of bytes of read data being represented by the given response flit than when the data size indication indicates a smaller number of bytes of read data being represented by the given response flit. This may recognize that response flits representing a greater number of bytes of read data may represent a larger fraction of the overall amount of data accessed from memory by a given requester interface circuitry than response flits representing fewer number of bytes of read data, so it can be beneficial to weight more strongly the status updates from response flits representing a greater number of bytes (since prioritising measures to relieve busyness of components that are able to send larger chunks of data in fewer transfers may tend to benefit processing performance for the software that uses that data).

On the other hand, in other examples, the status aggregation circuitry may select a lower weighting for the status indication of the given response flit when the data size indication is indicative of a greater number of bytes of read data being represented by the given response flit than when the data size indication indicates a smaller number of bytes of read data being represented by the given response flit. This may recognize that, from the point of view of a given memory system component, if it is unable to make use of the data elision functions because the data it needs to transmit does not fit one of the prescribed encodings able to be represented more efficiently in a compressed format, then it will need to send a greater number of response flits to the requester interface circuitry, and so any resource constraints that cause blocking of the response flits from the component sending fewer bytes per flit might cause the buffers that hold data awaiting transmission to remain blocked for longer than if a larger number of bytes can be transferred in one flit. Hence, from this point of view a system designer might choose to assign a higher weight to a response flit representing a smaller number of bytes than a response flit representing a larger number of bytes.

Which of these approaches is preferred may depend on system-specific issues, so for some system implementations it may be preferred to weight response flits representing a larger number of bytes more highly than response flits representing a smaller number of bytes, and for other system implementations it may be preferred to do the opposite, assigning a higher weighting to response flits representing a smaller number of bytes than response flits representing a larger number of bytes. Either way, considering information on the data size when determining the weighting may help provide more information on the extent to which considering the status information in the aggregation function is likely to benefit overall system performance.

In some examples, the data size indication comprises data-elision information indicating that one or more elided bytes of read data have been omitted from the given response flit and can be reconstructed at the requester interface circuitry based on the data-elision value, the data-elision information having fewer bits than said one or more elided bytes of read data.

The status aggregation circuitry can apply various aggregation functions for determining the aggregate status indication based on status indications received from a number of response flits. In general, the aggregation function may be any function which provides a summary of the collective values of the set of status indications obtained using the response flits.

However, in some examples, the status aggregation circuitry may track the aggregate status indication using a status counter. In response to the given response flit, the status aggregation circuitry may update the status counter by a variable amount selected depending on said at least one further response flit property of the given response flit, where the aggregate status indication depends on the status counter. Such a status counter could be used to track the number of response flits in a given period for which the status information has a particular value, for example. If the status information can take more than two possible values, there could be multiple counters available corresponding to different values of the status information, and the status counter to be updated in response to a given response flit may be selected based on the value of the status information provided by the given response flit. Where multiple status counters are provided, the count values tracked by the respective status counters could be combined to select an operating mode for an associated memory access request generator, such as a prefetcher, or another component involved in regulating the rate of initiation of transactions to the interconnect (e.g. control logic responsible for managing a request queue in which transactions awaiting delivery to the interconnect are buffered – that control logic could apply rate control based on the status counters). An advantage of using the status counter approach for tracking an aggregate status indication is that it can be relatively simple to apply variable weighting of updates by adjusting the increment/decrement amount by which the status counter is updated in response to detecting that the status information for a given response flit has a particular value.

There can be a number of ways in which the weighting can be reduced or increased for a given response flit in comparison to another response flit, depending on the at least one further response flit property of the given response flit.

In some examples, when the at least one further response flit property satisfies a zero-weighting condition, the status aggregation circuitry is configured to select a zero weighting to cause the status indication of the given response flit to have no influence on the aggregate status indication. Hence, it is possible, for some response flits of a class or type identified based on the at least one further response flit property, to suppress the corresponding update to the aggregate status indication, e.g. by not sampling the status indication from that response flit, filtering out the update entirely, or by selecting a zero weighting as an input to the aggregate function in cases when the at least one further response flit property satisfies a zero-weighting condition.

In other examples, a lower weighting could be applied by selecting a lower non-zero weighting, which is lower than a higher weighting used for other response flits. For example, when the at least one further response flit property satisfies a first non-zero-weighting condition, the status aggregation circuitry may select a first non-zero weighting for the status indication of the given response flit; and when the at least one further response flit property satisfies a second non-zero-weighting condition, the status aggregation circuitry may select a second non-zero weighting for the status indication of the given response flit, the second non-zero weighting being greater than the first non-zero weighting.

The control circuitry may use the aggregate status indication to control rate of initiation of memory system transactions to the memory system interconnect. In some examples, the rate control could influence non-speculative memory system transactions, which could be throttled based on the aggregate status indication (e.g. if the aggregate status indication indicates that the memory system is likely to be heavily overloaded, non-speculative memory system transactions could be held back).

However, as non-speculative memory system transactions represent demand accesses for which a read/write operation is actually required, it may be preferable to focus any throttling back of memory access transactions on speculative memory system transactions which are not known to be architecturally correct and might turn out not to be needed. Speculative memory system transactions may be useful to be issued in advance of the time when the corresponding memory read/write operation is definitely needed, so that the delay in obtaining any memory data from the underlying data storage can be overlapped with the delay in resolving whether the memory access is correct, to reduce overall access latency. Hence, often issuing speculative memory system transactions benefits overall processing performance. However, speculative memory system transactions also increase the resource demand on the memory system and so sometimes when the memory system is heavily overloaded, issuing too many speculative memory system transactions can actually harm performance since the speculative memory system transactions may occupy buffers or other structures with limited capacity within the memory system, causing blocking of other non-speculative memory system transactions which are more critical to performance. Hence, in some examples it can be useful for the control circuitry to control, based on the aggregate status indication, a rate of speculative memory system transactions initiated to the memory system interconnect. For example, the control circuitry could reduce the rate of speculative memory system transactions when the aggregate status indication indicates that the memory system is more heavily loaded and increase the rate of speculative memory system transactions when the aggregate status indication indicates that the memory system is more lightly loaded.

This technique could be used for controlling the rate of any kind of speculative memory access transaction (e.g. controlling the rate of memory access transactions issued speculatively based on data value predictions, for example).

However, this technique can be particularly useful for controlling a rate of prefetch memory system transactions initiated to the memory system interconnect. Modern processors have sophisticated prefetch mechanisms which can predict in advance the address patterns likely to be accessed in future some distance ahead of the point when program flow catches up with the point at which those memory accesses are required. However, such prefetchers can cause a lot of additional memory system bandwidth to be consumed in processing the prefetch requests, so if there is resource pressure at a given memory system component, this could lead to another non-speculative data accesses becoming blocked behind prefetch requests which were speculative and so not required to be issued. While prefetchers may benefit performance in the majority of scenarios, it may be preferable to reduce prefetcher aggression in cases of high system load. The aggregate status indication can therefore be used to control rate of prefetch memory system transactions, to better balance overall system performance depending on current resource utilisation status.

Some examples could apply rate control at a point of the memory transaction processing path that is shared between speculative and non-speculative memory system transactions (e.g. at a request queue in which both prefetch-triggered memory system transactions generated by a prefetcher and demand-triggered memory system transactions generated by load/store circuitry based on executed load/store instructions are buffered), in which case the rate control based on the aggregate status indication may affect both speculative and non-speculative memory system transactions.

The control circuitry can control the rate of memory system transactions (e.g. rate of speculative memory system transactions, or prefetch memory system transactions) in different ways. In some examples, the rate of memory system transactions may be directly controlled, e.g. by prescribing limits on the maximum memory bus bandwidth allowed to be used for transactions from a given requester, a maximum number of outstanding transactions that can be pending at a given time, or a prescribed rate of injecting the memory system transactions from a request queue. However, in some examples, the rate of memory system transactions may be controlled more indirectly, e.g. by selecting one of a number of prefetcher operating modes or by enabling or disabling different prefetcher types (enabling/disabling different combinations of prefetchers or adjusting operating mode for a given prefetcher may influence the rate of generation of memory system transactions by the prefetcher, but without providing explicit targets for a specific rate of memory system transaction to be generated).

Specific examples are now set out with reference to the drawings.

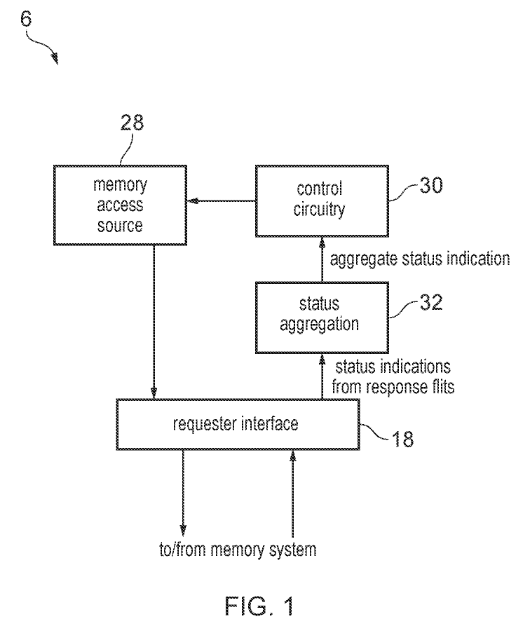

FIG. 1 schematically illustrates an example of an apparatus 6 which comprises a requester interface 18 by which memory system transactions are issued to a memory system and responses to the transactions are received from the memory system. For example, the apparatus 6 may be a processor, e.g. a central processing unit (CPU). The requester interface 18 may receive response flits from the memory system, where a response flit provides a (complete or partial) response to a memory system transaction initiated by the requester interface circuitry 18 to the memory system. Here the term “flit” refers to a basic unit of transfer on memory system interconnect (the term “flit” can be seen as a contraction of “flow control digit”). A given memory system transaction may involve the exchange of a number of flits as part of the transaction flow. The size of a given flit can be variable as the interconnect protocol used by the memory system interconnect may support communication links of the interconnect network having different data channel widths. In some examples, the flit is the unit of granularity with which routing decisions are made to determine the path by which the flit is routed across one or more memory system interconnects.

A given response flit received from the memory system at the requester interface circuitry 18 may specify a status indication providing information about the status of a corresponding memory system node associated with the response flit. For example, the status indication can indicate busyness status, providing information about the current level of activity of the associated memory system node. Status aggregation circuitry 32 receives the status indications sampled from a number of response flits received at the requester interface circuitry 18, and aggregates the status indications to form an aggregate status indication which provides a summary of the collective properties of the set of status indications received in a given sampling window. The aggregate status indication is provided to control circuitry 30 which controls a rate with which a corresponding memory access source 28 initiates memory system transactions to be supplied to the memory system via the requester interface circuitry 18. For example, the control circuitry 30 could use the aggregate status indication as an input to a control algorithm for selecting a current operating mode for the memory access source 28, adjusting threshold values or other control values which govern whether or not a given memory system transactions can be initiated by the memory access source 28 at a given time, and/or imposing limits on the maximum number of memory system transactions initiated within a given period. The memory access source 28 could be any part of a processor or other apparatus capable of initiating memory system transactions. It can be particularly useful to apply the control based on the aggregate status indication to a memory access source 28 which generates speculative memory system transactions which are issued to memory speculatively at a time when it is not yet known whether the read/write operation represented by the transaction will actually be needed. For example, the speculative transaction could be a transaction issued to an address predicted based on an operand determined by a data value prediction, or a prefetch request issued by a prefetcher. In one particular example, the memory access source 28 is a data prefetcher for prefetching data into a cache of the processor 6 in advance of any instruction actually requiring that data to be loaded, and the control circuitry 30 may control the operating mode of the data prefetcher (e.g. by adjusting operating mode to increase or reduce level of aggression of prefetching, such that when a more aggressive prefetching mode is selected then a greater rate of speculative prefetch memory system transactions are initiated via the requester interface circuitry 18 and when a less aggressive prefetching mode is selected then a lower rate of speculative prefetch memory system transactions are initiated via the requester interface circuitry 18). For example, a more aggressive prefetching mode could have, in comparison to a less aggressive prefetching mode, a lower confidence threshold defining a minimum level of prediction confidence required for a prefetch address prediction to cause a corresponding memory system transaction to be initiated.

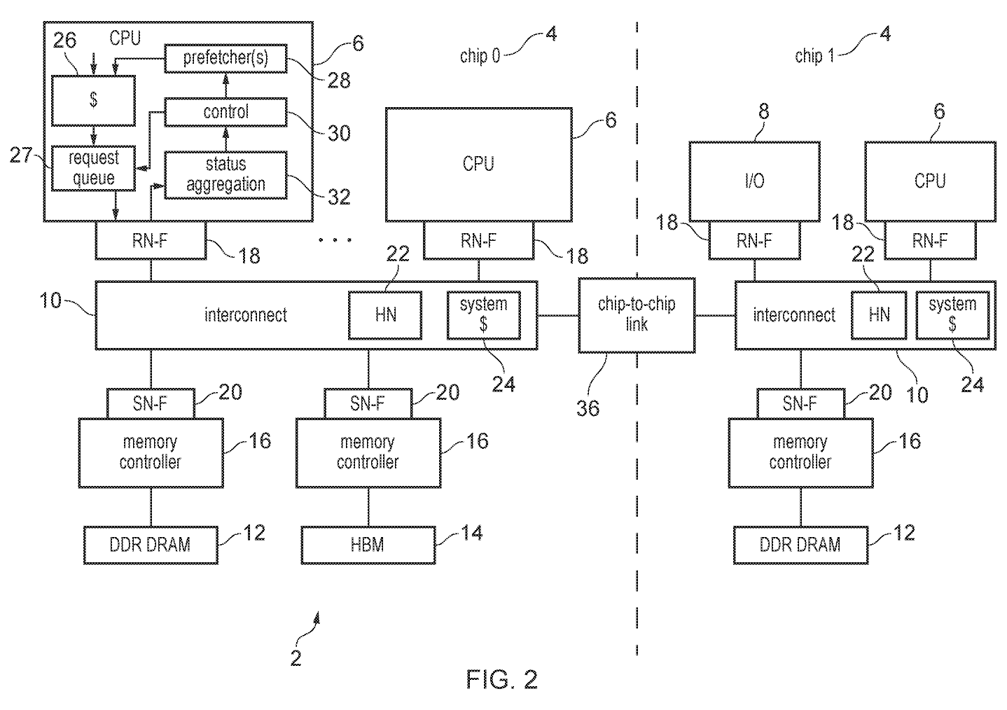

FIG. 2 illustrates a data processing system 2 including at least one instance of the apparatus (processor) 6 of FIG. 1. In this example, the system 20 includes three processors (in this example, central processing units, CPUs) 6 each having a corresponding instance of a requester interface 18, status aggregation circuitry 32, control circuitry 30 and memory access source 28 as discussed with respect to FIG. 1 (for conciseness, these components are only shown explicitly for one of the CPUs 6, but could also be provided in the other CPUs 6).

It is not essential for all CPUs 6 in the system 2 to have the status aggregation circuitry 32, control circuitry 30 and memory access source 28. In this example, the memory access source 28 comprises one or more prefetchers for prefetching data into a cache 26 speculatively in advance of the point of program flow when the data is actually needed. While not illustrated in FIG. 2 for conciseness, each CPU 6 may also include fetch circuitry for fetching instructions from an instruction cache or memory, decode circuitry for decoding the fetched instructions, and execution circuitry for performing data processing operations (e.g. arithmetic operations, logical operations, branch operations, load/store operations, etc.) in response to the decoded instructions.

In this example, a prefetcher is shown as an example of the access source 28 within a given CPU 6. A request queue 27 is provided for buffering memory access requests awaiting transfer to the memory system via the requester interface 18 of the CPU. The access requests queued in the request queue 27 can include both prefetch-triggered access requests generated based on prefetch predictions made by the prefetcher 28 and non-prefetch requests generated as demand accesses in response to load/store instructions processed by execution circuitry of the CPU 6. In some examples, the control circuitry 30 may use the aggregate state indication to control the rate at which requests are drained from the request queue 27, as well as (or instead of) controlling the prefetcher operating mode. This rate control for the request queue 27 may affect the rate of issue of both non-prefetch memory system transactions and prefetch memory system transactions.

The processors 6 each access a shared memory system via a memory system interconnect 10, which in this example is a coherent interconnect operating a coherency protocol to maintain coherency between data cached in the respective private caches 26 of each processor core 6 (other caching agents can also have such private caches 26 – e.g. although not shown in FIG. 2, other examples of caching agents could include graphics processing units (GPUs) or hardware accelerators). The system may also include input/output (I/O) devices 8 which, depending on the type of I/O device, may or may not have one or more private caches 26 subject to the coherency protocol.

The memory system interconnect 10 has home node circuitry 22 which implements a given coherency protocol, which defines a set of cache coherence transaction types and response protocols associated with those transaction types. Each address may, with respect to a particular caching agent, be considered to be held in that caching agent’s private cache 26 in a particular coherency state. For example, the coherency state may specify, with respect to a given address and a given caching agent 6, 8, whether valid data for that address is held at the given caching agent’s private cache 26, and if valid data is held, whether that data is clean or dirty, and/or is held in an exclusive (unique) or shared state (exclusive data being held exclusively in that caching agent’s private cache 26, and not in other caching agent’s private caches 26, while shared data is capable of being held in private caches of two or more caching agents simultaneously). When data is held in an exclusive state, the caching agent holding the data as exclusive is allowed to write to the data in the cache without first issuing coherence transactions to check with the home node 22 whether other caching agents could also be holding the data. When the data is held in a shared state, any write to the shared data in a given caching agent’s private cache would require first issuing a coherence transaction to check with the home node 32 whether there are conflicting copies in other caches 26 (e.g. that coherence transaction may typically be a request that the data in the given caching agent’s private cache 10 is upgraded to the exclusive coherency state, which may cause the home node 22 to send snoop requests to any other agents holding that data to trigger invalidation of data from those caching agents’ private caches 26). The home node circuitry 22 also manages any system level cache (SLC) or last-level cache (LLC), which is a shared cache 24, shared between multiple caching agents 6, 8. The shared cache 24 is also part of the coherency scheme managed by the home node circuitry 22. The coherency protocol implemented by the home node circuitry 22 may require that certain coherence transaction types or responses to such transactions may be associated with certain transitions of coherency state for cached items of data associated with the target address of the request (such coherency state transitions being managed based on snoop requests issued by the interconnect 10 to a corresponding caching agent 6, 8). Any known coherency protocol may be used for controlling the sequences of coherence transactions that occur when a given memory system transaction is requested by the requester interface 18 of a given requester 6, 8.

The interconnect 10 is also responsible for issuing memory access transactions to a subsidiary node interface 20 associated with a memory controller 16 which generates corresponding storage access requests to memory storage 12, 14 (the memory controller 16 may convert the interconnect protocol transactions generated by the interconnect 10 into storage-structure-specific requests for interacting with a specific memory cell array within the memory storage 12, 14). A number of distinct memory storage units 12, 14 may be provided, for example implementing different memory storage technologies (e.g. one or more instances of double data rate dynamic random access memory (DDR DRAM) storage 12, and one or more instances of high bandwidth memory (HBM) 14). Each memory storage unit 12, 14 may be associated with a corresponding memory controller 16 and subsidiary node interface 20.

In the particular example of FIG. 2, the processors 6 are distributed across multiple chips 4 (also known as chiplets). Each chip 4 comprises an integrated circuit formed on a separate semiconductor die. Respective memory system interconnects 10 on each chip 4 communicate via a chip-to-chip link 36. Use of multiple chiplets for implementing different parts of a data processing/memory system (of a type which traditionally would have been implemented instead as a system-on-chip on a single integrated circuit) can be helpful to allow for different semiconductor manufacturing nodes to be used to manufacture different portions of the system (e.g. reducing cost by manufacturing portions of the system which are less critical to performance at a less advanced manufacturing node), and can improve manufacturing yields by reducing the complexity on any one chiplet to reduce the probability that a given chiplet is faulty in manufacture compared to if the more complex whole system was implemented on a single die. It will be appreciated that the multi-chiplet system shown in FIG. 2 is just one example, and the status aggregation techniques discussed in this application could also be applied to single-chiplet systems.

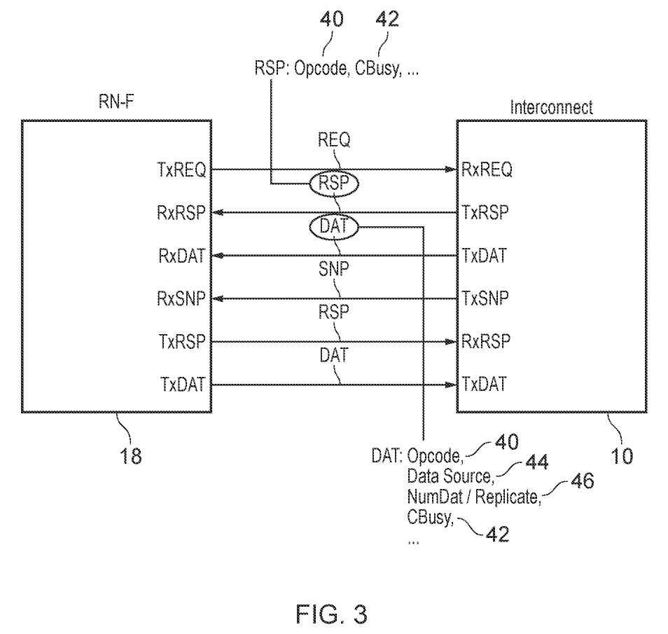

FIG. 3 illustrates an example of communication channels between the requester interface circuitry 18 of a given a requesting node (RN) (e.g. a processor 6) and the interconnect 10. The requester interface 18 is responsible for managing sending and receiving of messages via the communication channels, and the interconnect 10 has a corresponding message interface for managing receipt from, and sending of messages to, the requester interface 18. The link between the requester interface 18 and the interconnect’s interface includes a number of communication channels including:
a request channel REQ for sending request flits from the RN 6 to the interconnect 10. The request flits are for initiating a new transaction flow (memory system transaction), such as a new read or write transaction.
a data channel DAT including a first data path for sending write or snooped data from the RN 6 to the interconnect 10 and a second data path for sending read data from the interconnect 10 to the RN 6. Data flits providing payload data, such as read, write or snoop data, can be sent via the data channel DAT (e.g. write data being sent from RN 6 to interconnect 10 and read data being sent from interconnect 10 to RN 6).
a response channel RSP including a first response path for sending response flits from the RN 6 to the interconnect 10 (e.g. used for responses to snoop requests) and a second response path for sending response flits from the interconnect 10 to the RN 6 (e.g. used for read/write response messages sent in response to read/write transactions initiated by the RN 6 via the request channel REQ). The response flits may be used to communicate messages other than payload data, such as (for the second response path) write acknowledgement messages confirming that a write request has been serviced, read acknowledgement messages sent ahead of the data being transmitted on the corresponding DAT channel, and (for the first response path) snoop response messages indicating coherency status of a snooped address in the RN’s cache 26. It will be appreciated that these are just some examples of types of response flits that may be exchanged.
a snoop channel SNP used by the interconnect 10 to send a snoop flit to the RN 6 to query coherency status of a snoop target address in the RN’s cache 26 or to trigger changes in coherency state at the RN’s cache 26, such as a requesting an invalidation or cleaning operation. For requesters 8 such as an I/O controller that do not have a private cache 26, the snoop channel SNP could be omitted. Alternatively, some I/O agents may still have a snoop channel SNP for memory management unit coherency even if they do not have a coherent cache 26.

It will be appreciated that the particular set of channels shown in FIG. 3 may be particular to one example of a memory system interconnect protocol, and other examples could have a different set of channels.

As shown in FIG. 3, some types of response flits received by the requester interface 18 may specify a status indication 42 providing information about the status of an associated memory system node associated with the response flit. For example, a read/write response flit received on the response channel RSP may specify busyness status information (CBusy) 42. Similarly, a read data response flit received on the data channel DAT may specify the busyness status information 42. For example, the busyness status information 42 could be encoded as the field of one or more bits, representing one of a set of “busyness levels” of successively increasing busyness. For example, some examples may provide a single bit of busyness status information 42 (e.g. encoding busy/not-busy, or overloaded/not-overloaded), while other examples may provide two or more bits to encode finer-grained levels of busyness. The particular way in which a given memory system node determines the level of busyness may vary from one type of memory system node to another and between respective implementations of the same type of memory system node. The interconnect protocol architecture may not prescribe any particular way in which a memory system component designers should determine the level of busyness of a particular component, but in general there may be an architecturally understood protocol that defines, for a given pair of encodings of the busyness status information, which of those encodings represents a more busy state and which of those encodings represents the less busy state. In one example, a memory system node such as a memory controller 16, home node 22, system cache 24, chip-to-chip link 36, or a transaction routing component of the interconnect 10 could have a buffer for queuing pending requests awaiting servicing, and may determine the busyness status information 42 specified in response flits returned from that component based on a current buffer occupancy of the buffer at that memory system node 16, 22, 24, 36. For example, a number of buffer occupancy thresholds may be defined, and the value of the busyness status information 42 may be selected as a function of which of those thresholds has been exceeded by the current buffer occupancy. For example, a two-bit indication of busyness could be set as 0b00 (buffer less than 50% full), 0b01 (buffer greater than 50% full but less than or equal to 75% full), 0b10 (buffer greater than 75% full but less than or equal to 90% full), or 0b11 (buffer greater than 90% full). Clearly, this is just one particular example used to illustrate the principle, and other encodings and numbers of bits of the busyness indicator could be used.

It will be appreciated that the particular way in which a memory system node determines its level of busyness is not important, but in general an architectural mechanism is provided by which response flits received at a requester interface 18 for a particular processor 6 can be associated with busyness status information 42 tracking a level of busyness for an associated memory system node. The associated memory system node whose level of busyness is indicated by the status information 42 does not necessarily need to be the originating memory system node from which the response flit was generated but could also be an intermediate component via which the response flit is routed to the requester interface 18. For example, when accessing stored data from a memory storage unit 12, 14 on a remote chip 4 other than the chip comprising the requester interface 18, if the chip-to-chip link 36 detects that its own level of busyness is greater than that indicated using the busyness status information 42 specified by the memory controller 16 for that memory storage unit 12, 14, the chip-to-chip link 36 could update the busyness status information 42 in the response flit forwarded on to the requester interface 18, as given the slow chip-to-chip communication latency it may be useful to communicate the busy status of the chip-to-chip link 36 to the requester interface 18 even if the underlying memory storage 12, 14 is not necessarily busy.

As well as specifying the status information 42, a given response flit may also be associated with at least one further response flit property which indicates information about the response flit. In some cases, the at least one further response flit property need not necessarily be represented by an explicit parameter encoded in the response flit itself. For example, whether the response flit is a RSP channel response flit received on the response channel RSP or a data channel response flit received on the data channel DAT may implicitly identify information about the response flit.

However, a given response flit may also encode one or more parameters specifying further response flit properties. For example, both RSP channel response flits and DATA channel response flits may specify a response opcode 40 identifying the type of response flit. For example, for the RSP channel, the opcode 40 could distinguish snoop, read or write responses, and for the DAT channel, the opcode 40 could distinguish snoop and read data responses and/or distinguish whether a read data response is a combined response/data response flit that provides both read acknowledgement and read data, or is a data only response flit on the DAT channel sent separately from an earlier non-data-providing read response returned on the RSP channel in response to the same read transaction.

Also, the read data response for the DAT channel could specify one or more further parameters, including one or more of: a data source identifier 44 identifying the data source node which provided the read data. For example, the data source identifier 44 could identify whether the data was obtained from the system cache 24, from another requester’s private cache 26, from a specific memory storage 12, 14 unit, or from an I/O device 8, and could also help distinguish whether the data was obtained from a node on the same chip 4 as the requester interface 18 that receives the data or from a node on a remote chip 4 different from the chip 4 comprising the requester interface 18 that receives the data. data elision information 46 (an example of data size information) indicating whether one or more elided bytes of read data have been omitted from the read data response flit and can be reconstructed at the requester interface circuitry 18 based on the data elision information 46. In cases where such bytes of data are omitted because they fit one of the elision patterns supported by the interconnect protocol, the data elision information 46 has fewer bits than the one or more elided bytes of read data that are omitted from the response flit. For example, the data elision information 46 may indicate: NumDat: identifying the number of bytes that have been elided and are to be reconstructed at the requester interface 18. Replicate: a parameter identifying how to reconstruct the omitted bytes of data, e.g. indicating whether the omitted bytes are a repetition of the byte/bytes of data that are explicitly encoded in the read data response flit, or can be reconstructed as having a predetermined known value (e.g. zero).

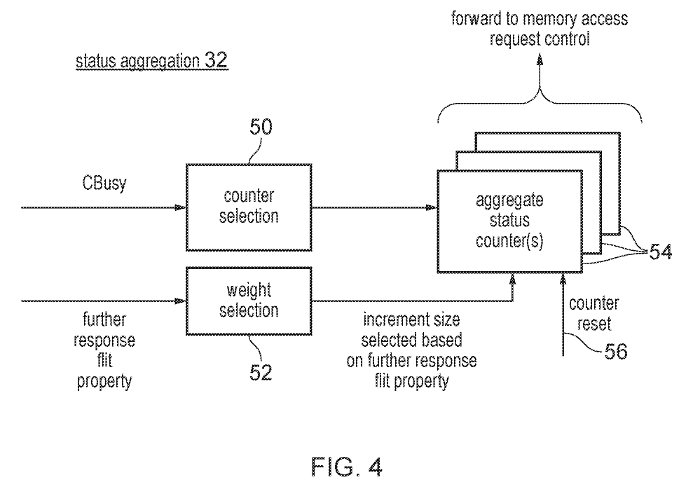

FIG. 4 illustrates an example of the status aggregation circuitry 32 for generating at least one aggregate status indication based on the status indications (CBusy fields) 42 extracted from a number of response flits received at a given processor’s requester interface 6 over a period of time. In this example, the status aggregation circuitry 32 maintains a number of aggregate status counters 54 which, at a start of a sampling period, are reset to an initial value such as zero (e.g. a counter reset signal 56 may be asserted at the start of each sampling period, to clear all counters to the initial value). Each aggregate status counter 54 in this example corresponds to a different encoding of the CBusy field 50 (e.g. in the 2-bit example provided above, separate counters could be provided for counting occurrences of response flits specifying the 0b01, 0b10, 0b11 busyness values respectively – it may not be essential to provide a counter for counting occurrences of response flits specifying the lowest level of busyness as that may be considered the default state). Hence, when a given response flit is received, the busyness status indication 42 of that response flit may be used by counter selection circuitry 50 to select which of the aggregate status counters 54 is to be updated in response to that response flit. While FIG. 4 shows an example with multiple aggregate status counters, other examples may provide only a single aggregate status counter.

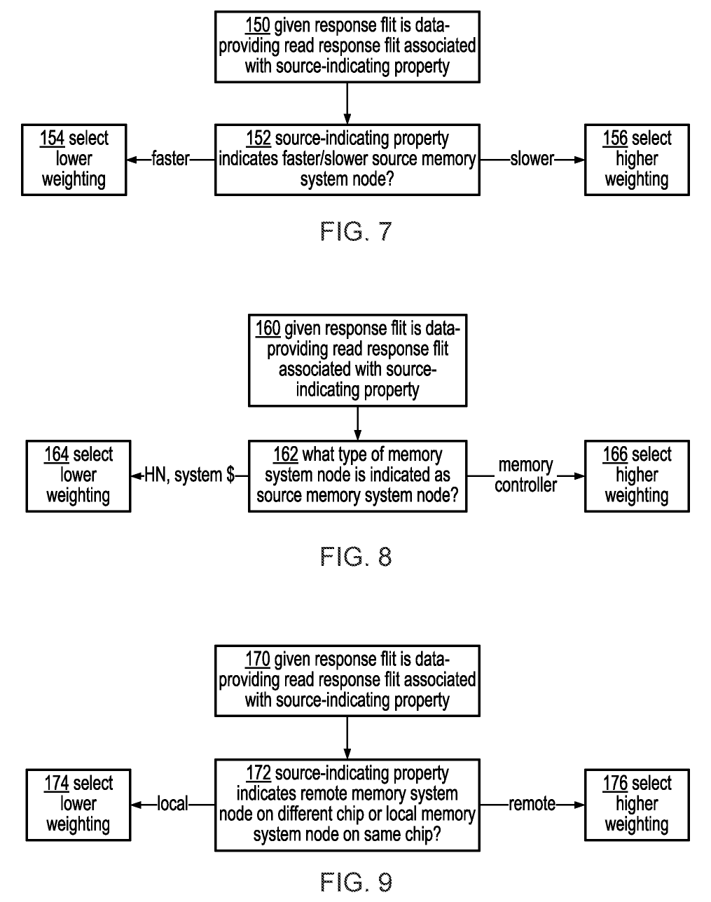

Weight selection circuitry 52 is provided to select, based on at least one further response flit property (e.g. the information about which channel the response flit is received on, and/or one or more of the further parameters 40, 44, 46 encoded by the response flit), a weighting defining the influence the corresponding item of status information 42 has on the corresponding aggregate status value 54. For example, in this example, the weight selection circuitry 52 selects a variable increment size based on the at least one further response flit property, which defines the amount by which the aggregate status counter 54 selected by counter selection circuitry 50 is incremented in response to this response flit. The weighting / increment size could be zero (to cause the status information (CBusy) 42 from the current response flit to have no influence on the aggregate status information at all), or could be non-zero (to cause the status information (CBusy) 42 from the current response flit to have some influence on the aggregate status information – if a non-zero weighting is selected then some examples may select between two or more alternative non-zero weightings). For example, some examples may select the increment size as one of 0, 1 or 2, depending on the at least one further response flit property 40, 44, 46. Other examples may support other weightings or increment sizes greater than 2, or could support fractional weightings or increment sizes. Various specific examples of how to select the weighting based on the further response flit property are set out below with respect to FIGS. 7 to 12. While in FIG. 4, the variable increment size is selected based on at least one further response flit property and independent of the status information 42 itself, other examples may select a variable increment size as a function of both the status information 42 and the at least one further response flit property (e.g. if a single aggregate status counter is provided shared between values of the status field 42, the increment amount may be higher for status information fields 42 that indicate the highest busy status than for status information fields 42 that indicate a less busy status).

The aggregate status values tracked by the counters 54 can be read out periodically (e.g. at the end of a sampling period) by the control circuitry 30, to determine a control parameter for controlling rate of memory system transactions initiated to the memory system interconnect 10 by the requester interface circuitry 18. The control circuitry 30 could control the rate of initiation of memory system transactions to the interconnect 10 in a variety of different ways.

In some examples, the rate is controlled by regulating the rate of generation of memory system transactions by an associated memory access source 28. For example, a prefetcher mode of operation may be selected for the next sampling period based on the count values read out from the aggregate status counters 54 at the end of the current sampling period. In one example, a number of prefetcher modes may be implemented, and the current count values may cause whether a transition is made from one prefetcher mode to another. For example, a set of operating modes may include, in order from most aggressive to least aggressive, mode A (fully aggressive mode on inaccurate prefetchers), mode B (moderately aggressive mode on inaccurate prefetchers), mode C (conservative mode on inaccurate prefetchers), and mode D (disable inaccurate prefetchers). For example, the respective modes may correspond to different settings for which prefetcher types are active and/or confidence thresholds used to determine whether a prefetch address prediction of a given level of confidence is sufficient to justify issuing a corresponding memory system transaction.

In some examples, the rate of initiation of memory system transactions can be controlled by regulating the rate at which memory system transactions are drained from the request queue 27 to issue those transactions to the interconnect 10 via the requester interface 18. This may indirectly affect the rate at which prefetch requests or other speculative requests are issued to the interconnect 10, but could also affect the rate at which non-speculative demand-driven read/write transactions generated in response to executed load/store instructions are issued to the interconnect 10.

Regardless of the particular way in which rate control of transactions issued to the interconnect 10 is implemented, the control circuitry 30 may implement a state machine defining rules for transitioning between one operating mode and the next (e.g. the different operating modes may vary in terms of level of prefetcher aggression for the prefetcher 28, or in a setting for rate control of issuing requests from the request queue 27). For example, a given mode transition may depend on a Boolean combination of one or more comparison functions, each comparison function comprising a determination of whether a given one of the aggregate status counters 54 exceeds or does not exceed a corresponding threshold. There is a lot of design choice available for defining the particular count thresholds and Boolean rules for determining the point at which a mode transition should occur, so the particular state transition rules are not an essential feature of this technique. In general, by adjusting the prefetcher operating mode based on one or more counts of the number of response flits specifying CBusy values 42 indicating a given level of busyness within a recent sampling window, this can help provide a balance between responding fast enough to changes in system load conditions so as to throttle back speculative prefetches if the system is becoming overloaded, and not responding too hastily to a temporary overloading which might leave some performance on the table which could have been used as that overload condition was short-lived.

An advantage of applying a variable weighting to the counter update, depending on at least one property of the response flit other than the status information field 42 itself, is that this can reduce the tendency for over-throttling of prefetch requests or other speculative access requests which might otherwise occur if all status updates 42 provided by response flits were given equal weighting. This is because not all memory system nodes have equal latency and bandwidth requirements. A memory system node that can tolerate higher request bandwidth and/or can service requests with lower average latency will, for a given level of loading of that component, typically have less impact on overall system performance than a memory system node that can service a lower maximum bandwidth or tends to have a higher overall access latency. Therefore, it can be useful, for example, to assign higher weightings to response flits that specify a response flit property 40, 44, 46 indicating that they are associated with a response type or source node that is more likely to represent a pinch point that is influential in affecting overall system performance.

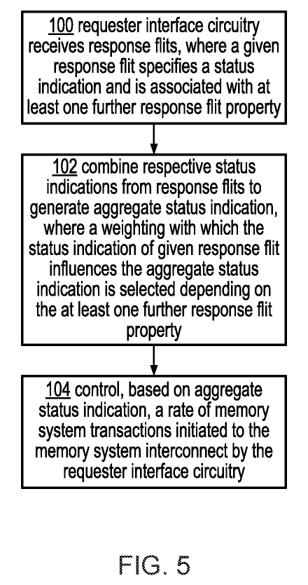

FIG. 5 illustrates method steps for controlling the rate of memory system transactions based on the status indications from response flits. At step 100, the requester interface circuitry 18 of a given processor 6 receives response flits from the memory system interconnect 10, where a given response flit specifies a status indication 42 and is associated with at least one further response flit property 40, 44, 46. At step 102, the status aggregation circuitry 32 combines respective status indications from the response flits to generate an aggregate status indication, where a weighting with which the status indication of a given response flit influences the aggregate status indication is selected depending on the at least one further response flit property 40, 44, 46 of the given response flit. At step 104, the control circuitry 30 controls, based on the aggregate status indication generated at step 102, a rate of memory system transactions initiated to the memory system interconnect 10 by the requester interface circuitry 18. For example, the control circuitry 30 can select the current prefetcher operating mode for the prefetch circuitry 28 based on the aggregate status indication.

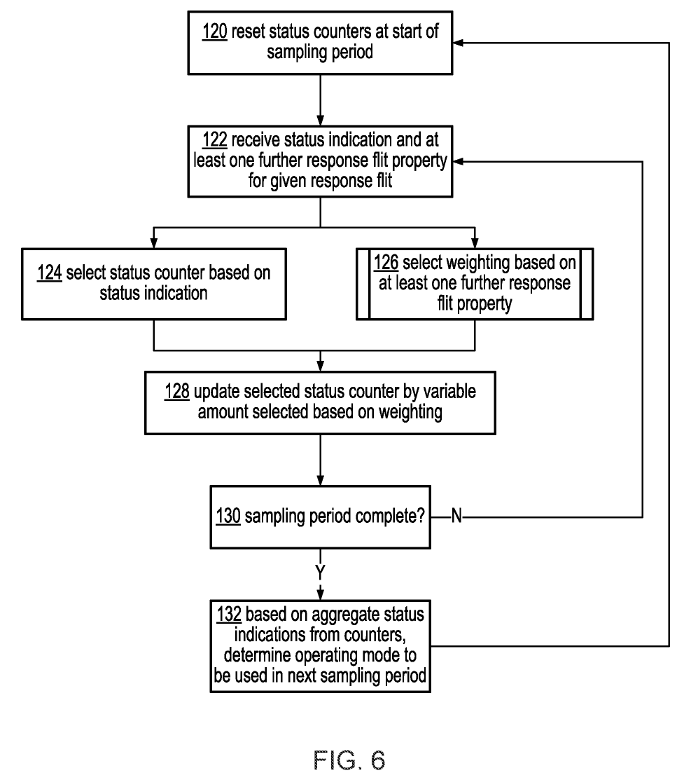

FIG. 6 illustrates a more detailed example for controlling the rate of initiation of memory system transactions based on status information 42 obtained from response flits received at the requester interface circuitry 18. At step 120, the status aggregation circuitry 32 resets its aggregate status counters 54 at the start of a sampling period. At step 122, the status aggregation circuitry 32 receives a status indication 42 and at least one further response flit property 40, 44, 46 obtained for a given response flit received at the requester interface circuitry 18. At step 124, the counter selection circuitry 50 selects one of the status counters 54 based on the value of the status indication 42 for the given response flit, and at step 126 the weight selection circuitry 52 selects a weighting for the given response flit based on the at least one further response flit property of the given response flit. At step 128, the status aggregation circuitry 32 updates the status counters 54 selected at step 124 by a variable increment/decrement amount selected based on the weighting selected at step 126. At step 130, the status aggregation circuitry 32 determines whether the current sampling period is complete. For example, the end of the sampling period could be determined when a predetermined period of time has elapsed, or when a predetermined number of response flits have been detected. If the sampling period is not yet complete, then the method repeats steps 122 to 130 for the next response flit processed in the sampling period. Once the sampling period is complete, at step 132, the current values of each status counter 54 are read out and supplied to the control circuitry 30, and the control circuitry 30 determines, based on the values of the aggregate status indications from each status counter 54, an operating mode to be used in the next sampling period by a component responsible for generation or processing of memory access transactions (e.g. that component could be the prefetch circuitry 28, which may select prefetcher operating mode and/or prefetch generation rate based on the status indications, and/or control logic associated with the request queue 27 which may control rate of dispatch of requests to the interconnect based on the status indications).

FIGS. 7 to 12 illustrate various examples of the weight selection step 126 of FIG. 6.

FIG. 7 illustrates an example where the further response flit property used to select the weighting is a source-indicating property directly or indirectly indicative of which memory system node is the source memory system node from which the response flit is received. At step 150, the weight selection circuitry 50 determines, for a given response flit, that the given response flit is a data-providing read response flit associated with the source-indicating property. For example, the source-indicating property could be the data source field 44 of a read data response flit, and/or could include information inferred from the opcode 40 of a response flit and/or from other information such as whether the response flit was received on the DAT channel or RSP channel. At step 152, the weight selection circuitry 50 determines whether the source-indicating property indicates that the source memory system node is a faster source memory system node or a slower source memory system node (whether a particular source memory system node is considered faster or slower may be assessed based on the relative access latencies associated with responses from that node that are received at the requester interface 18 for the particular processor 6 that comprises this instance of the weight selection circuitry 50). If the source memory system node is a faster source memory system node, then a lower weighting is selected at step 154 (e.g. the lower weighting corresponding to a smaller increment of the status counter 54). If the source memory system node is a slower source memory system node, then a higher weighting is selected at step 156 (e.g. the higher weighting corresponding to a larger increment of the status counter 54). It will be appreciated that in some examples steps 152, 154, 156 may be implemented by defining, for the weight selection circuitry 50, a lookup table or similar circuit logic that obtains, for each source node identifier, a corresponding weight value or increment size value defining the weighting with which the corresponding aggregate status update is to be applied. The weight/increment size values may be chosen by a system designer so that, in general, the faster memory system nodes are assigned lower weightings and the slower memory system nodes are assigned higher weightings. Hence, it is not necessary that an assessment of relative access latencies is carried out at runtime by the weight selection circuitry (the assessment of relative access latencies may have been pre-defined in the lookup table by the system designer).

FIG. 8 illustrates a more specific example of considering a source-indicating property when selecting a weighting. Again, at step 160, the weight selection circuitry 50 determines, for a given response flit, that the given response flit is a data-providing read response flit associated with the source-indicating property. At step 162, the weight selection circuitry 50 determines the type of memory system node that is indicated as the source memory system node by the source-indicating property. If the source memory system node is home node circuitry 22 or a shared system cache 24, then a lower weighting is selected at step 164, while if the source memory system node is a memory controller 16 associated with memory storage circuitry 12, 14 then a higher weighting selected at step 166. This recognises that constraints in available resource at memory controllers 16 are more likely to impact overall system performance than resource constraints at the home node 22 or system cache 24, since the access latency is slower for the underlying memory storage 12, 14 than for the home node 22 or system cache 24 and so any slowdown in response due to insufficient resource capacity is much more impactful for accesses targeting a memory controller 16 than accesses targeting the home node 22 or system cache 24. Therefore, it can be desirable to assign higher weightings to indications of high busyness from the memory controllers 16 than from the home node 22 or system cache 24.

FIG. 9 illustrates another more specific example of considering a source-indicating property when selecting a weighting. Again, at step 170, the weight selection circuitry 50 determines, for a given response flit, that the given response flit is a data-providing read response flit associated with the source-indicating property. At step 172, the weight selection circuitry 50 determines whether the source-indicating property indicates that the node associated with the busy status information 42 is on a same (local) chip 4 as the requester interface circuitry 18 that received the response flit or is on a different (remote) chip 4 from the chip 4 comprising the requester interface circuitry 18 that received the response flit. If the node associated with the busy status information 42 is on a local chip (the same chip as the requester interface circuitry 18 receiving the response flit) then a lower weighting is selected at step 174, while if the node associated with the busy status information 42 is on a remote chip then a higher weighting is selected at step 176. Again, this will tend to prioritise busy status updates made by nodes on remote chips, to which overall system performance is particularly sensitive due to the slower communication latency on the chip-to-chip link 36, and reduces the likelihood of overthrottling back rates of prefetches which might be unnecessary if the only busy component is a component on the same chip as the requester interface circuitry 18.

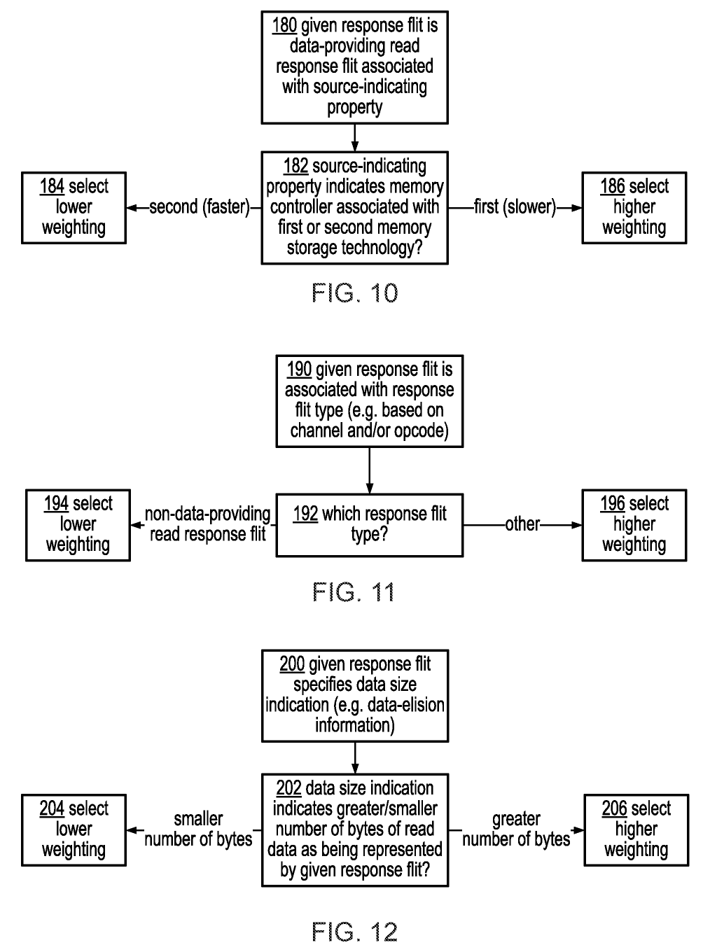

FIG. 10 illustrates another more specific example of considering a source-indicating property when selecting a weighting. Again, at step 180, the weight selection circuitry 50 determines, for a given response flit, that the given response flit is a data-providing read response flit associated with the source-indicating property. At step 182, the weight selection circuitry 50 determines whether the source-indicating property indicates that the node associated with the busy status information 42 uses a first memory storage technology or a second memory storage technology. For example, the first memory storage technology could be DRAM 12 and the second memory storage technology could be HBM 14 (so that the first memory storage technology is expected to offer lower maximum bandwidth and/or higher average access latency than the second memory storage technology). If the source node is implemented using the slower first memory storage technology, then at step 186 a higher weighting is selected, while if the source node implements storage using the faster second memory storage technology then at step 184 a lower weighting is selected.

FIG. 11 illustrates another example of the weight selection step 126, in which for this example the further response flit property is an indication of response flit type (which could be determined based on the opcode 40 of the response flit and/or on the channel on which the response flit is received). At step 190, the weight selection circuitry 50 determines, for a given response flit, that the given response flit is associated with a response flit type, and identifies the response flit type at step 192. If the response flit type is a non-data-providing read response flit received on the response channel RSP separate from a subsequent data-providing read response flit sent for the same read transaction on the data channel DAT, then at step 194 a lower weighting is selected, while a higher weighting is selected at step 196 for other flit types (including the data-providing read response flit, as well as other types of response flits such as write response flits, snoop response flits, cache maintenance response flits, etc.). Defining a lower weighting for non-data-providing read response flits (e.g. in some cases a zero weighting, so that aggregate status count updates are filtered out altogether when a non-data-providing read response flit returns the status information 42) can be helpful because typically the non-data-providing read response flit is returned by the home node 22 and so is less representative of overall system load conditions than the busy status 42 indicated by response flits that provide read data from underlying memory storage 12, 14. From simulation results, it has been found that filtering out the status count updates that would otherwise be performed when busy status information 42 is returned in a non-data-providing read response flit can be helpful to improve overall performance by reducing the unnecessary suppression of prefetches that could otherwise arise.

FIG. 12 illustrates another example of the weight selection step 126, in which for this example the further response flit property is a data size indication (e.g. the data-elision information 46) which indicates a size of read data represented by a given response flit. At step 200, the weight selection circuitry identifies, for a given response flit, that this response flit provides data size information, and at step 202 determines whether the data size indicates a greater or smaller number of bytes of read data as being represented by this response flit (e.g. step 202 may compare the represented number of bytes with a threshold to determine whether the number of bytes is considered greater or smaller). If the number of bytes is smaller than a given threshold, then at step 204 a lower weighting is selected, while if the number of bytes is greater than a given threshold, then at step 206 a higher weighting is selected (if the number of bytes equals the threshold then either the lower or higher weighting could be selected depending on design choice). Biasing the aggregate status updates in favour of response flits representing a greater number of bytes can be helpful as it means the busyness status of a component that satisfies a requester’s demand for a larger number of bytes of the data required by the requester 6 is given greater prominence than the busyness status of a component that does not provide as much of the data required by the requester 6.

It will be appreciated that the examples of FIGS. 7 to 12 are non-exhaustive and illustrate some considerations that could be taken when selecting the weighting. It will be appreciated that two or more of the factors shown in FIGS. 7 to 12 could be combined in some examples. Also, in some cases it is not essential to explicitly determine, at runtime, the relative access latencies, memory storage technology types, memory system node types, etc. that inform some of the criteria shown in FIGS. 7 to 12. In some cases this analysis could be carried out at design time by a system designer, to prescribe for particular source nodes or response types the corresponding weighting that should be selected for response flits from that source node, so that the weight selection circuitry 50 merely implements a predefined lookup table mapping a source node identifier and/or response type information to a corresponding weight value, but does not need to compare relative access latencies from particular memory system nodes, say, or be aware of which particular memory storage technologies are implemented at particular remote nodes.

Concepts described herein may be embodied in a system comprising at least one packaged chip. The apparatus described earlier (e.g. the CPU 6, or the data processing system 2) is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

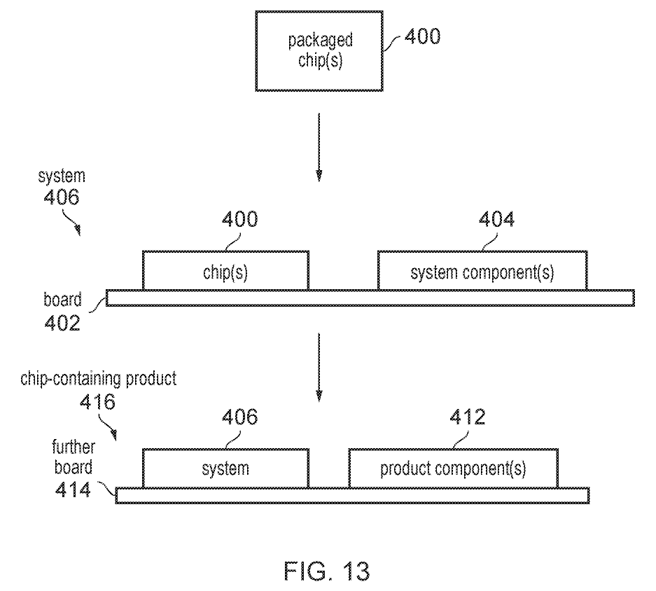

As shown in FIG. 13, one or more packaged chips 400, with the apparatus 6 or 2 described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Some examples are set out in the following clauses:

### 1. An apparatus comprising:

requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication;

status aggregation circuitry configured to combine respective status indications from a plurality of response flits received by the requester interface circuitry to generate an aggregate status indication; and

control circuitry configured to control, based on the aggregate status indication generated by the status aggregation circuitry, a rate of memory system transactions initiated to the memory system interconnect by the requester interface circuitry; in which:

the status aggregation circuitry is configured to select, depending on said at least one further response flit property of the given response flit received by the interface circuitry, a weighting with which the status indication of the given response flit influences the aggregate status indication.

2. The apparatus according to clause 1, in which the status indication comprises a busyness indication indicative of a level of busyness for the memory system node associated with the given response flit.

3. The apparatus according to any of clauses 1 and 2, in which the at least one further response flit property used by the status aggregation circuitry to select the weighting comprises a source-indicating property indicative of a source memory system node for the given response flit.

4. The apparatus according to clause 3, in which, at least when the given response flit is a response flit of at least one predetermined response flit type, the status aggregation circuitry is configured to select a higher weighting for the status indication of the given response flit when the source-indicating property indicates a slower source memory system node expected to provide slower access latency for servicing memory system transactions initiated by the requester interface circuitry than when the source-indicating property indicates a faster source memory system node expected to provide faster access latency for servicing memory system transactions initiated by the requester interface circuitry.

5. The apparatus according to any of clauses 3 and 4, in which, at least when the given response flit is a response flit of at least one predetermined response flit type, the status aggregation circuitry is configured to select a higher weighting for the status indication of the given response flit when the source-indicating property indicates that the source memory system node is a memory controller configured to control access to an associated array of random access memory cells, than when the source-indicating property indicates that the source memory system node is home node circuitry configured to manage coherency of data held by a plurality of caches associated with a plurality of requesters or a system cache shared between the plurality of requesters.

6. The apparatus according to any of clauses 3 to 5, in which, at least when the given response flit is a response flit of at least one predetermined response flit type, the status aggregation circuitry is configured to select a higher weighting for the status indication of the given response flit when the source-indicating property indicates that the source memory system node is a remote memory system node on a different chip to the requester interface circuitry, than when the source-indicating property indicates that the source memory system node is a local memory system node on a same chip as the requester interface circuitry.

7. The apparatus according to any of clauses 3 to 6, in which, at least when the given response flit is a response flit of at least one predetermined response flit type, the status aggregation circuitry is configured to select a higher weighting for the status indication of the given response flit when the source-indicating property indicates that the source memory system node is a memory controller associated with a memory storage array implemented according to a first memory storage technology than when the source-indicating property indicates that the source memory system node is a memory controller associated with a memory storage array implemented according to a second memory storage technology.

8. The apparatus according to any of clauses 4 to 7, in which said at least one predetermined response flit type comprises a data-providing read response flit which provides read data returned in response to a read memory system transaction initiated by the requester interface circuitry.

9. The apparatus according to any of clauses 1 to 8, in which the at least one further response flit property used by the status aggregation circuitry to select said weighting comprises a response flit type associated with the given response flit.

10. The apparatus according to clause 9, in which the status aggregation circuitry is configured to select a lower weighting for the status indication of the given response flit when the given response flit is a non-data-providing read response flit than when the given response flit is at least one other type of response flit;

said non-data-providing read response flit comprising a response flit returned in response to a read memory system transaction initiated by the requester interface circuitry and being separate from a data-providing read response flit providing read data returned in response to the read memory system transaction.

11. The apparatus according to any of clauses 1 to 10, in which the at least one further response flit property used by the status aggregation circuitry to select said weighting comprises a data size indication indicative of a number of bytes of read data represented by the given response flit as being returned in response to a corresponding read memory system transaction.

12. The apparatus according to clause 11, in which the status aggregation circuitry is configured to select a higher weighting for the status indication of the given response flit when the data size indication is indicative of a greater number of bytes of read data being represented by the given response flit than when the data size indication indicates a smaller number of bytes of read data being represented by the given response flit.

13. The apparatus according to any of clauses 11 and 12, in which the data size indication comprises data-elision information indicating that one or more elided bytes of read data have been omitted from the given response flit and can be reconstructed at the requester interface circuitry based on the data-elision value, the data-elision information having fewer bits than said one or more elided bytes of read data.

14. The apparatus according to any of clauses 1 to 13, in which, in response to the given response flit, the status aggregation circuitry is configured to update a status counter by a variable amount selected depending on said at least one further response flit property of the given response flit, and the aggregate status indication depends on the status counter.

15. The apparatus according to any of clauses 1 to 14, in which, when the at least one further response flit property satisfies a zero-weighting condition, the status aggregation circuitry is configured to select a zero weighting to cause the status indication of the given response flit to have no influence on the aggregate status indication.

16. The apparatus according to any of clauses 1 to 15, in which:

when the at least one further response flit property satisfies a first non-zero-weighting condition, the status aggregation circuitry is configured to select a first non-zero weighting for the status indication of the given response flit;

when the at least one further response flit property satisfies a second non-zero-weighting condition, the status aggregation circuitry is configured to select a second non-zero weighting for the status indication of the given response flit, the second non-zero weighting being greater than the first non-zero weighting.

17. The apparatus according to any of clauses 1 to 16, in which the control circuitry is configured to control, based on the aggregate status indication, a rate of speculative memory system transactions initiated to the memory system interconnect.

18. The apparatus according to any of clauses 1 to 17, in which the control circuitry is configured to control, based on the aggregate status indication, a rate of prefetch memory system transactions initiated to the memory system interconnect.

19. A system comprising:

the apparatus of any of clauses 1 to 18, implemented in at least one packaged chip;

at least one system component; and

a board,

wherein the at least one packaged chip and the at least one system component are assembled on the board.

20. A chip-containing product comprising the system of clause 19, wherein the system is assembled on a further board with at least one other product component.

21. A non-transitory computer-readable medium storing computer-readable code for fabrication of an apparatus comprising:

requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication;

status aggregation circuitry configured to combine respective status indications from a plurality of response flits received by the requester interface circuitry to generate an aggregate status indication; and

control circuitry configured to control, based on the aggregate status indication generated by the status aggregation circuitry, a rate of memory system transactions initiated to the memory system interconnect by the requester interface circuitry; in which:

the status aggregation circuitry is configured to select, depending on said at least one further response flit property of the given response flit received by the interface circuitry, a weighting with which the status indication of the given response flit influences the aggregate status indication.

22. A method comprising:

receiving a plurality of response flits at requester interface circuitry in response to memory system transactions initiated to a memory system interconnect by the requester interface circuitry, a given response flit specifying a status indication indicative of a status of a memory system node associated with the given response flit, where the given response flit is associated with at least one further response flit property other than the status indication;

combining respective status indications from the plurality of response flits received by the requester interface circuitry to generate an aggregate status indication, wherein a weighting with which the status indication of the given response flit influences the aggregate status indication is selected depending on said at least one further response flit property of the given response flit; and

controlling, based on the aggregate status indication, a rate of memory system transactions initiated to the memory system interconnect by the requester interface circuitry.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication;
status aggregation circuitry configured to combine respective status indications from a plurality of response flits received by the requester interface circuitry to generate an aggregate status indication; and
control circuitry configured to control, based on the aggregate status indication generated by the status aggregation circuitry, a rate of memory system transactions initiated to the memory system interconnect by the requester interface circuitry; in which:
the status aggregation circuitry is configured to select, depending on said at least one further response flit property of the given response flit received by the interface circuitry, a weighting with which the status indication of the given response flit influences the aggregate status indication.

2. The apparatus according to claim 1, in which the status indication comprises a busyness indication indicative of a level of busyness for the memory system node associated with the given response flit.

3. The apparatus according to claim 1, in which the at least one further response flit property used by the status aggregation circuitry to select the weighting comprises a source-indicating property indicative of a source memory system node for the given response flit.

4. The apparatus according to claim 3, in which, at least when the given response flit is a response flit of at least one predetermined response flit type, the status aggregation circuitry is configured to select a higher weighting for the status indication of the given response flit when the source-indicating property indicates a slower source memory system node expected to provide slower access latency for servicing memory system transactions initiated by the requester interface circuitry than when the source-indicating property indicates a faster source memory system node expected to provide faster access latency for servicing memory system transactions initiated by the requester interface circuitry.

5. The apparatus according to claim 3, in which, at least when the given response flit is a response flit of at least one predetermined response flit type, the status aggregation circuitry is configured to select a higher weighting for the status indication of the given response flit when the source-indicating property indicates that the source memory system node is a memory controller configured to control access to an associated array of random access memory cells, than when the source-indicating property indicates that the source memory system node is home node circuitry configured to manage coherency of data held by a plurality of caches associated with a plurality of requesters or a system cache shared between the plurality of requesters.

6. The apparatus according to claim 3, in which, at least when the given response flit is a response flit of at least one predetermined response flit type, the status aggregation circuitry is configured to select a higher weighting for the status indication of the given response flit when the source-indicating property indicates that the source memory system node is a remote memory system node on a different chip to the requester interface circuitry, than when the source-indicating property indicates that the source memory system node is a local memory system node on a same chip as the requester interface circuitry.

7. The apparatus according to claim 3, in which, at least when the given response flit is a response flit of at least one predetermined response flit type, the status aggregation circuitry is configured to select a higher weighting for the status indication of the given response flit when the source-indicating property indicates that the source memory system node is a memory controller associated with a memory storage array implemented according to a first memory storage technology than when the source-indicating property indicates that the source memory system node is a memory controller associated with a memory storage array implemented according to a second memory storage technology.

8. The apparatus according to claim 4, in which said at least one predetermined response flit type comprises a data-providing read response flit which provides read data returned in response to a read memory system transaction initiated by the requester interface circuitry.

9. The apparatus according to claim 1, in which the at least one further response flit property used by the status aggregation circuitry to select said weighting comprises a response flit type associated with the given response flit.

10. The apparatus according to claim 9, in which the status aggregation circuitry is configured to select a lower weighting for the status indication of the given response flit when the given response flit is a non-data-providing read response flit than when the given response flit is at least one other type of response flit;
said non-data-providing read response flit comprising a response flit returned in response to a read memory system transaction initiated by the requester interface circuitry and being separate from a data-providing read response flit providing read data returned in response to the read memory system transaction.

11. The apparatus according to claim 1, in which the at least one further response flit property used by the status aggregation circuitry to select said weighting comprises a data size indication indicative of a number of bytes of read data represented by the given response flit as being returned in response to a corresponding read memory system transaction.

12. The apparatus according to claim 11, in which the status aggregation circuitry is configured to select a higher weighting for the status indication of the given response flit when the data size indication is indicative of a greater number of bytes of read data being represented by the given response flit than when the data size indication indicates a smaller number of bytes of read data being represented by the given response flit.

13. The apparatus according to claim 11, in which the data size indication comprises data-elision information indicating that one or more elided bytes of read data have been omitted from the given response flit and can be reconstructed at the requester interface circuitry based on the data-elision value, the data-elision information having fewer bits than said one or more elided bytes of read data.

14. The apparatus according to claim 1, in which, in response to the given response flit, the status aggregation circuitry is configured to update a status counter by a variable amount selected depending on said at least one further response flit property of the given response flit, and the aggregate status indication depends on the status counter.

15. The apparatus according to claim 1, in which the control circuitry is configured to control, based on the aggregate status indication, a rate of speculative memory system transactions initiated to the memory system interconnect.

16. The apparatus according to claim 1, in which the control circuitry is configured to control, based on the aggregate status indication, a rate of prefetch memory system transactions initiated to the memory system interconnect.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of an apparatus comprising:
requester interface circuitry configured to initiate memory system transactions to a memory system interconnect and to receive, in response to the memory system transactions, response flits from the memory system interconnect, wherein a given response flit specifies a status indication indicative of a status of a memory system node associated with the given response flit, and the given response flit is associated with at least one further response flit property other than the status indication;
status aggregation circuitry configured to combine respective status indications from a plurality of response flits received by the requester interface circuitry to generate an aggregate status indication; and
control circuitry configured to control, based on the aggregate status indication generated by the status aggregation circuitry, a rate of memory system transactions initiated to the memory system interconnect by the requester interface circuitry; in which:
the status aggregation circuitry is configured to select, depending on said at least one further response flit property of the given response flit received by the interface circuitry, a weighting with which the status indication of the given response flit influences the aggregate status indication.

20. A method comprising:
receiving a plurality of response flits at requester interface circuitry in response to memory system transactions initiated to a memory system interconnect by the requester interface circuitry, a given response flit specifying a status indication indicative of a status of a memory system node associated with the given response flit, where the given response flit is associated with at least one further response flit property other than the status indication;
combining respective status indications from the plurality of response flits received by the requester interface circuitry to generate an aggregate status indication, wherein a weighting with which the status indication of the given response flit influences the aggregate status indication is selected depending on said at least one further response flit property of the given response flit; and
controlling, based on the aggregate status indication, a rate of memory system transactions initiated to the memory system interconnect by the requester interface circuitry.
